(19) United States
(12) Patent Application Publication
(10) Pub. No.: US 2013/0178103 A1
(43) Pub. Date: Jul. 11, 2013

(54) SAFETY PLUG ASSEMBLY

(71) Applicant: Wen-Cheng Tsai, Taichung City (TW)

(72) Inventor: Wen-Cheng Tsai, Taichung City (TW)

(21) Appl. No.: 13/346,074

(22) Filed: Jan. 9, 2012

(51) Int. Cl. H01R 13/68

(52) U.S. Cl. 439/620.26

(57) ABSTRACT

A safety plug assembly has a plug head, two resilient conductive members, two conductive bodies and a plug base. The plug head is insulated and has a plug cavity and two holding recesses. The plug cavity is defined in the front side. The holding recesses are defined longitudinally in the bottom of the plug cavity. The resilient conductive members are mounted respectively in the holding recesses. The wires are connected respectively with the resilient conductive members. The conductive bodies are respectively mounted slidably in the holding recesses in the plug head and abut respectively with the resilient conductive members. At least one of the conductive bodies is a fuse. The plug base is insulated, is mounted detachably in the plug cavity and has two plug plates abutting respective with the conductive bodies.

### BACKGROUND OF THE INVENTION

1. Field of the Invention

The present invention relates to a plug assembly, and more particularly to a safety plug assembly having at least one fuse.

2. Description of Related Art

An electrical apparatus has a plug for inserting into a wall socket to transmit electrical power to the electrical apparatus. However, the conventional plug does not have a fuse. When the plug is inserted into a socket that has a high or unstable voltage, the electrical apparatus is easily damaged.

To overcome the shortcomings, the present invention tends to provide a plug assembly to mitigate or obviate the aforementioned problems.

### SUMMARY OF THE INVENTION

The main objective of the invention is to provide a safety plug assembly having at least one fuse.

The safety plug assembly has a plug head, two resilient conductive members, two conductive bodies and a plug base. The plug head is insulated and has a front side, a rear side opposite to the front side, a plug cavity and two holding recesses. The plug cavity is defined in the front side and has a bottom. The holding recesses are defined longitudinally in the bottom of the plug cavity. The resilient conductive members are mounted respectively in the holding recesses. The wires are connected respectively with the resilient conductive members and extend out of the rear side of the plug head. The conductive bodies are respectively mounted slidably in the holding recesses in the plug head and abut respectively with the resilient conductive members. At least one of the conductive bodies is a fuse. The plug base is insulated, is mounted detachably in the plug cavity in the plug head and has a front side, a rear side and two plug plates. The plug plates are mounted through the plug base and align respectively with the holding recesses. Each plug plate has a front end and a rear end. The front end protrudes from the front side of the plug base. The rear end extends out of the rear side of the plug base and abuts with one of the conductive bodies.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a safety plug assembly in accordance with the present invention;

FIG. 2 is a perspective view of the safety plug assembly in FIG. 1;

FIG. 3 is a side view in partial section of the safety plug assembly in FIG. 1; and

FIG. 4 is an operational side view in partial section of the safety plug assembly in FIG. 1.

### DETAILED DESCRIPTION OF PREFERRED EMBODIMENT

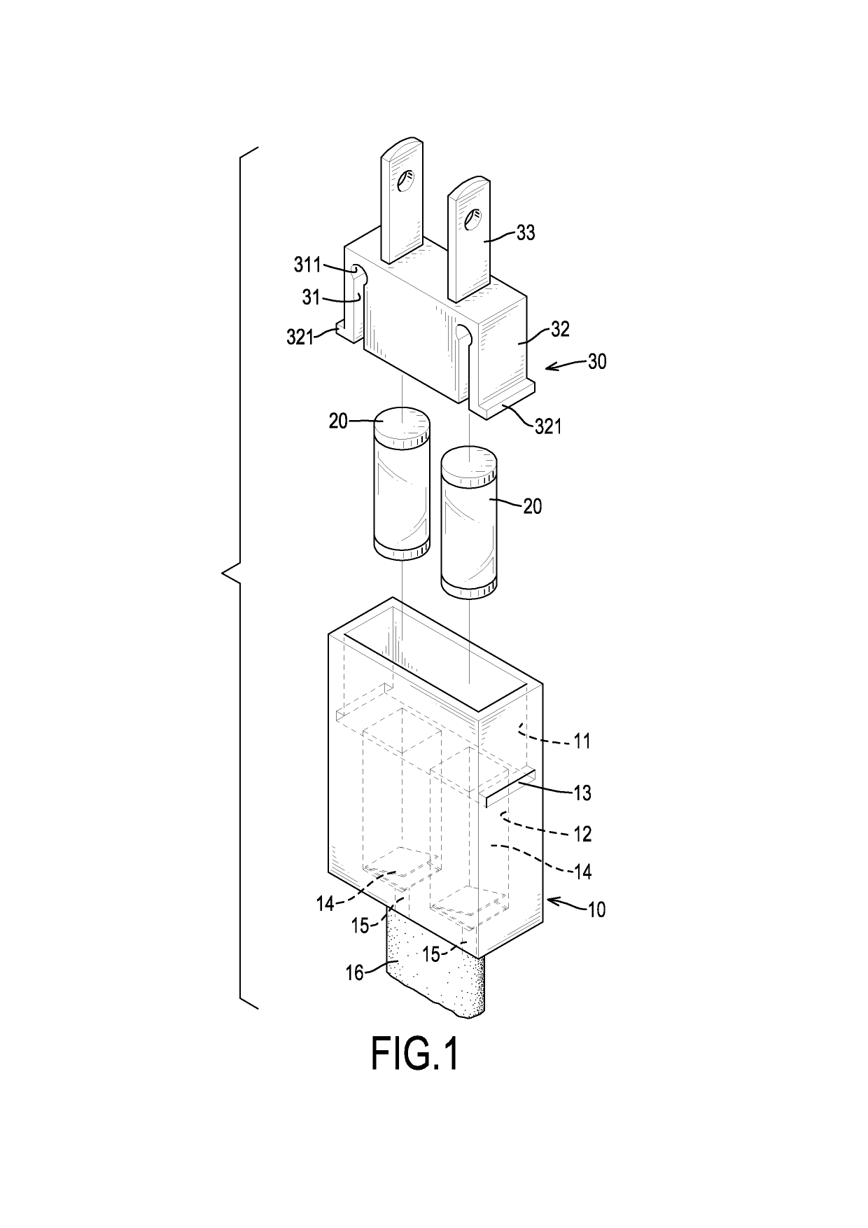

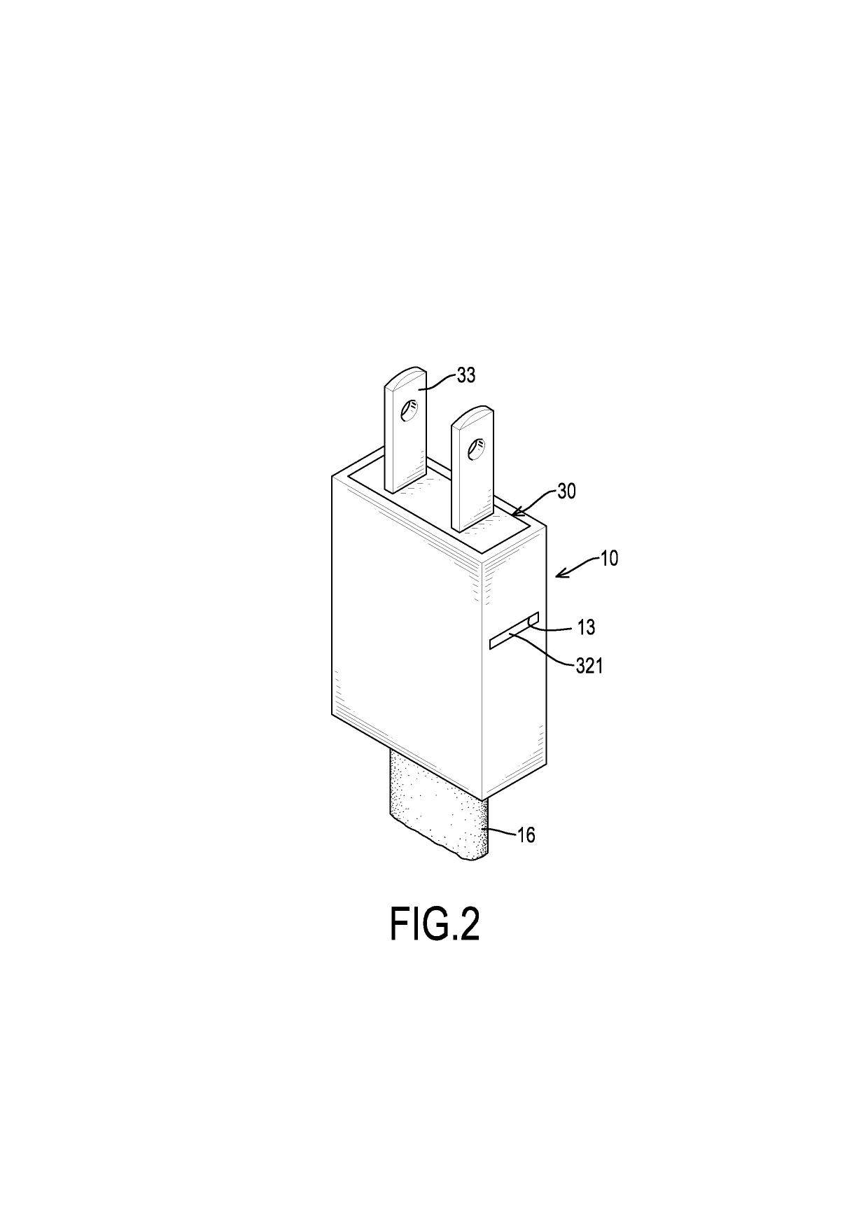

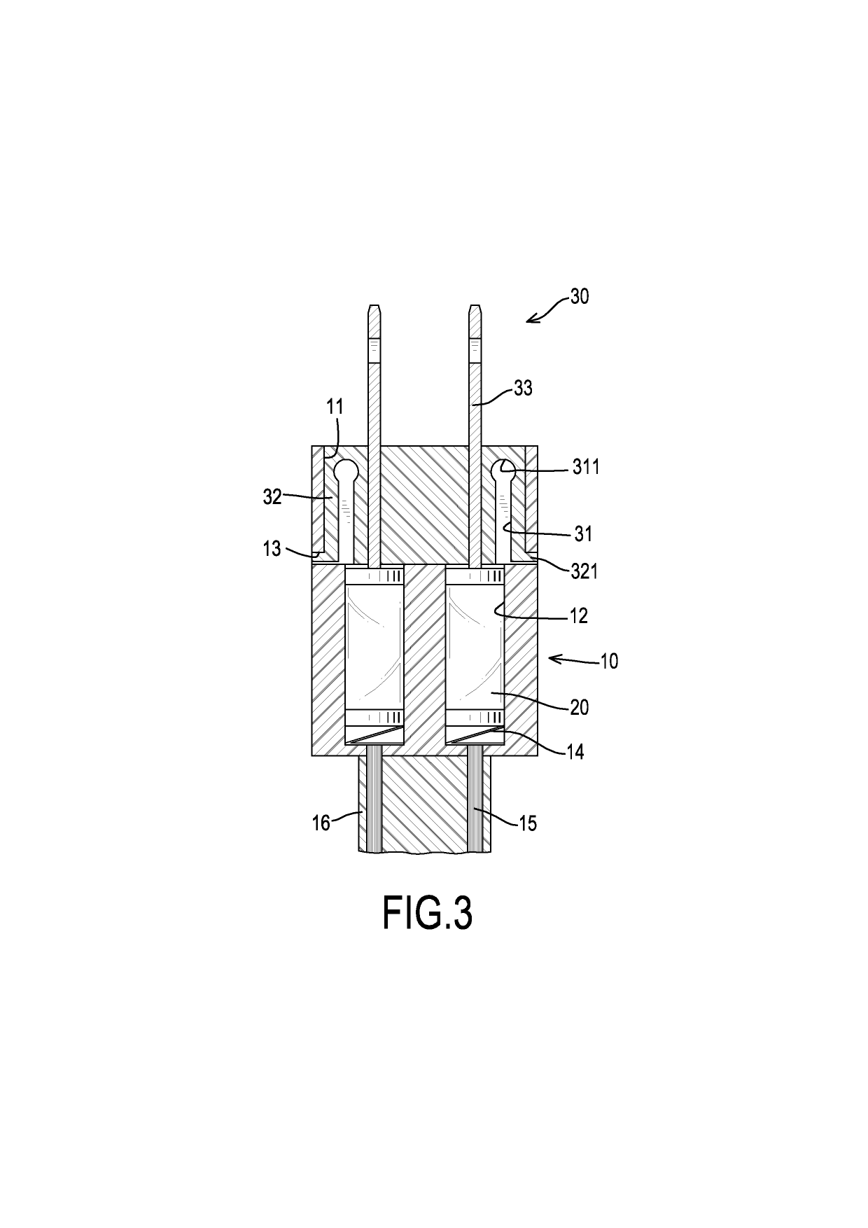

With reference to FIGS. 1 to 3, a safety plug assembly in accordance with the present invention comprises a plug head 10, two resilient conductive members 14, two wires 15, two conductive bodies 20 and plug base 30.

The plug head 10 is insulated, is rectangular in cross section and has a front side, a rear side opposite to the front side, a plug cavity 11, two holding recesses 12 and two engaging holes 13. The plug cavity 11 is defined in the front side, may be rectangular in cross section and has a bottom. The holding recesses 12 are defined longitudinally in the bottom of the plug cavity 11, extend toward the rear side of the plug head 10 and may be rectangular in cross section. The engaging holes 13 are defined respectively in two opposite side surfaces of the plug cavity 11. Preferably, the engaging holes 13 are elongated and defined through the side surfaces of the plug head 10.

The resilient conductive members 14 are mounted respectively in the holding recesses 12. Preferably, the resilient conductive members 14 are V-shaped resilient strips as shown. Alternatively, the resilient conductive members 14 may be springs.

The wires 15 are connected respectively with the resilient conductive members 14 and extend out of the rear side of the plug head 10. In addition, an insulated coat 16 is mounted around the two wires 15 and is connected to the rear side of the plug head 10.

The conductive bodies 20 are respectively mounted slidably in the holding recesses 14 in the plug head 10 and abut respectively with the resilient conductive members 14. At least one of the conductive bodies 20 is a fuse. Preferably, one of the conductive bodies 20 is a fuse, and the other conductive body 20 is a metal rod. Alternatively, both of the conductive bodies 20 are fuses.

The plug base 30 is insulated, is mounted detachably in the plug cavity 11 in the plug head 10, may be rectangular in cross section and has a front side, a rear side and two plug plates 33. To mount the plug base 30 in the plug cavity 11, the plug base 30 has two resilient slits 31 defined in the rear side of the plug base 30 to form two resilient engaging arms 32 on the plug base 30. In addition, each resilient slit 31 has a bottom provided with an enlarged hole 311. The enlarged hole 311 has a diameter larger than the width of the resilient slit 31 and is round. With the arrangement of the enlarged holes 311, the resilience of the engaging arms 32 can be enhanced.

Each engaging arm 32 has an engaging block 321 formed on the free end of the engaging arm 32 and engaging one of the engaging holes 13 in the plug head 10. With the engagement between the engaging blocks 321 on the engaging arms 32 and the engaging holes 13, the plug base 30 is mounted detachably in the plug cavity 11.

The front side of the plug base 30 is flush with the front side of the plug head 10. The plug plates 33 are mounted through the plug base 30 and align respectively with the holding recesses 14. Each plug plate 33 has a front end and a rear end. The front end protrudes from the front side of the plug base 30. The rear end extends out of the rear side of the plug base 30 and abuts with one of the conductive bodies 20, such that the plug plates 33 are electrically connected with the wires 15 via the conductive bodies 20 and the resilient conductive members 14. In addition, the plug head 10, the plug cavity 11, the holding recesses 12 and the plug base 30 may have a round or square cross section.

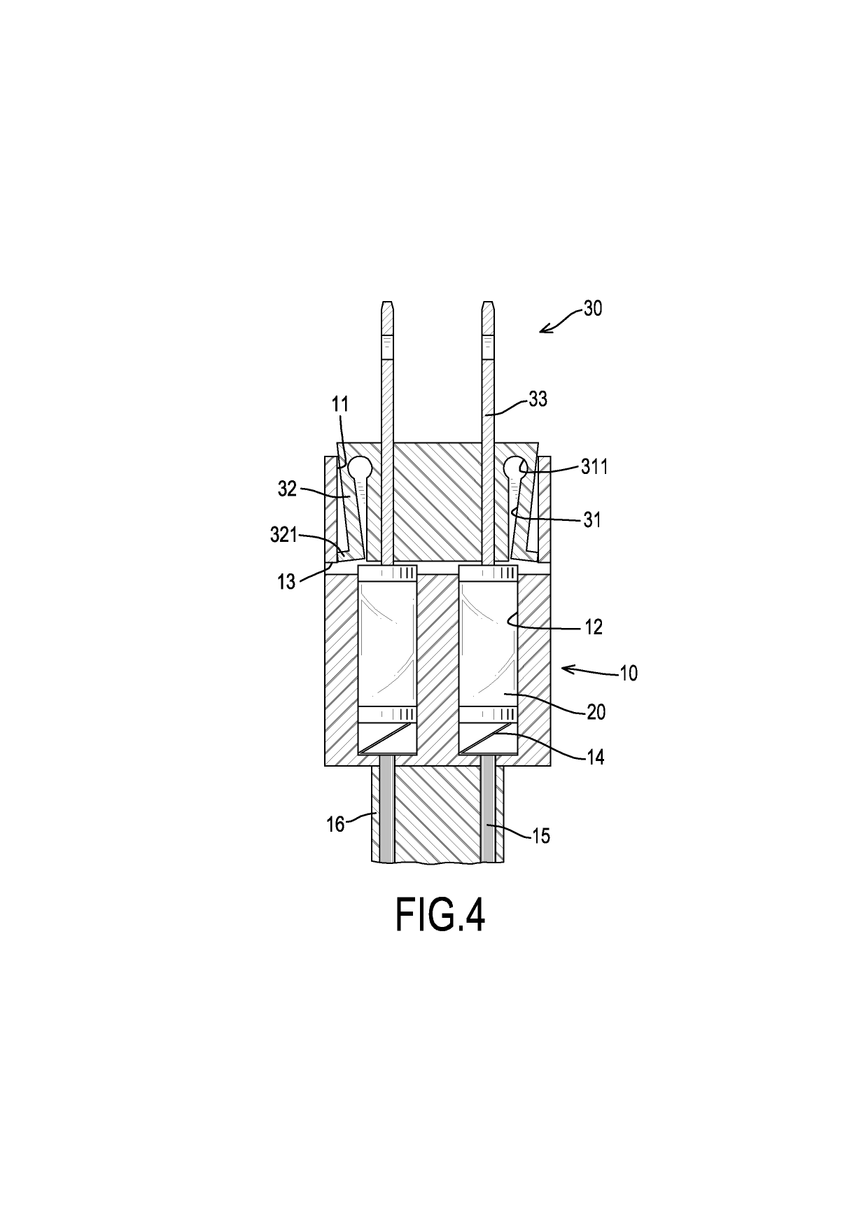

With reference to FIG. 4, before the plug base 30 being mounted into the plug cavity 11 of the plug head 10, the ends of the conductive bodies 20 extend out of the holding recesses 12. When the plug base 30 is mounted into the plug cavity 11, the engaging arms 32 are compressed to allow the engaging arms 32 with the engaging blocks 321 to enter into the plug cavity 11. When the plug base 30 is inserted into the plug cavity 11 to a position where the engaging blocks 321 align with the engaging holes 13, the engaging blocks 321 will automatically engage the engaging holes 13 due to the resilience of the engaging arms 32. At this time, the conductive bodies 20 will be pushed to retract into the holding recesses 12 by the rear side of the plug base 30 and abut with the rear ends of the plug plates 33. Thus, the plug plates 33 are electrically connected with the wires 15 via the conductive bodies 20 and the resilient conductive members 14.

When any one of the conductive bodies 20 is damaged or broken, the plug base 30 can be detached from the plug cavity 11 by disengaging the engaging blocks 321 from the engaging holes 13. Consequently, the damaged conductive body 20 can be replaced with a new one easily and conveniently.

When the plug assembly is inserted into a socket having a high or unstable voltage, the fuse may be broken due to the high or unstable voltage to form a broken circuit. Accordingly, the electrical apparatus connected with the plug assembly in accordance with the present invention can be prevent from being damaged due to the high or unstable voltage so as to provide a safety effect to the electrical apparatus.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A safety plug assembly comprising:
a plug head being insulated and having:
a front side;
a rear side opposite to the front side;
a plug cavity defined in the front side and having a bottom; and
two holding recesses defined longitudinally in the bottom of the plug cavity;
two resilient conductive members mounted respectively in the holding recesses;
two wires connected respectively with the resilient conductive members and extending out of the rear side of the plug head;
two conductive bodies respectively mounted slidably in the holding recesses in the plug head and abutting respectively with the resilient conductive members, wherein at least one of the conductive bodies is a fuse; and
a plug base being insulated, mounted detachably in the plug cavity in the plug head and having:
a front side;
a rear side; and
two plug plates mounted through the plug base and aligning respectively with the holding recesses, and each plug plate having:
a front end protruding from the front side of the plug base; and
a rear end extending out of the rear side of the plug base and abutting with one of the conductive bodies.

2. The safety plug assembly as claimed in claim 1, wherein
the plug head further has two engaging holes defined respectively in two opposite side surfaces of the plug cavity;
the plug base further has two resilient slit s defined in the rear side of the plug base to form two resilient engaging arms on the plug base; and
each engaging arm has an engaging block formed on the engaging arm and engaging one of the engaging holes in the plug head.

3. The safety plug assembly as claimed in claim 2, wherein the front side of the plug base is flush with the front side of the plug head; and both of the conductive bodies are fuses.

4. The safety plug assembly as claimed in claim 3, wherein
the plug head, the plug cavity, the holding recesses and the plug base are rectangular in cross section;
the resilient conductive members are V-shaped resilient strips; and
a coat is mounted around the two wires and is connected to the rear side of the plug head.

5. The safety plug assembly as claimed in claim 2, wherein
the plug head, the plug cavity, the holding recesses and the plug base are rectangular in cross section;
the resilient conductive members are V-shaped resilient strips; and
a coat is mounted around the two wires and is connected to the rear side of the plug head.

6. The safety plug assembly as claimed in claim 1, wherein
the plug head, the plug cavity, the holding recesses and the plug base are rectangular in cross section;
the resilient conductive members are V-shaped resilient strips; and
a coat is mounted around the two wires and is connected to the rear side of the plug head.
